(19) United States
(12) Patent Application Publication
(10) Pub. No.: US 2026/0097377 A1
(43) Pub. Date: Apr. 9, 2026

(54) DECREASING TRIBOELECTRIC CHARGING OF, AND/OR REACTOR FOULING BY, POLYOLEFIN PARTICLES

(71) Applicant: Univation Technologies, LLC, Houston, TX (US)

(72) Inventors: John F. Szul, Hurricane, WV (US); Kishori Deshpande, Pearland, TX (US); Poupak Mehrani, Ottawa (CA); Andrew Sowinski, Ottawa (CA); Mohsen Isaac Nimvari, Ottawa (CA); Nikhil Sridhar, Ottawa (CA)

(21) Appl. No.: 19/113,977

(22) PCT Filed: Dec. 12, 2023
(86) PCT No.: PCT/US2023/083483

§ 371 Date: Mar. 21, 2025

Related U.S. Application Data
(60) Provisional application No. 63/431,773, filed on Dec. 12, 2022.

(51) Int. Cl. B01J 8/18; B01J 8/22; B01J 8/24; C08F 10/02

(52) U.S. Cl. CPC B01J 8/1809; B01J 8/1827; B01J 8/22; B01J 8/24; C08F 10/02; B01J 2208/00707; B01J 2208/00734; B01J 2208/00938

(57) ABSTRACT

Methods described herein are directed to decreasing triboelectric charging of, and/or reactor fouling by, polyolefin particles, the methods comprising: feeding an argon gas/nitrogen gas mixture upward through the distributor plate into the reaction zone to fluidize the polyolefin particles in the reaction zone, wherein the argon gas/nitrogen gas mixture consists of from 5 volume percent (vol %) to no more than 65 vol % argon gas, from 95 vol % to no less than 10 vol % nitrogen gas, and from 0 vol % to no more than 5 vol % helium gas, wherein the sum of all these vol % equals 100 vol % of the argon gas/nitrogen gas mixture.

### FIELD OF THE DISCLOSURE

This disclosure relates to methods for decreasing triboelectric charging of, and/or reactor fouling by, polyolefin particles in a fluidized bed-type gas phase polymerization reactor.

### BACKGROUND

Polyolefins may be utilized for a number of products. Polyolefins can be formed by reacting one or more types of monomer in a polymerization reaction. Different polymerization processes and different reaction components can be utilized to make polyolefins having varying properties. There exists a continuing need for new and/or improved methods of making polyolefins.

### SUMMARY

Methods described herein are directed to decreasing triboelectric charging of, and/or reactor fouling by, polyolefin particles, the methods comprising: feeding an argon gas/nitrogen gas mixture upward through the distributor plate into the reaction zone to fluidize the polyolefin particles in the reaction zone, wherein the argon gas/nitrogen gas mixture consists of from 5 volume percent (vol %) to no more than 65 vol % argon gas, from 95 vol % to no less than 10 vol % nitrogen gas, and from 0 vol % to no more than 5 vol % helium gas, wherein the sum of all these vol % equals 100 vol % of the argon gas/nitrogen gas mixture.

Methods described herein are directed to lowering static in a fluidized bed-type gas phase polymerization reactor, the methods comprising: feeding a startup gas to the FBT-GPP reactor to provide a startup gas environment, wherein the startup gas consists of from 80 volume percent (vol %) to 100 vol % argon gas and 0 vol % to 20% nitrogen gas, wherein the sum of all these vol % equals 100 vol % of the startup gas.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWING

FIG. 1 depicts a schematic of an example gas phase polymerization system in accordance with a number of embodiments described herein.

FIG. 2 depicts a schematic of an example system in accordance with a number of embodiments described herein.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

For a number of applications, polymerization reactors, e.g., fluidized bed-type gas phase polymerization reactors (FBT-GPP reactor), may experience triboelectric charging and/or reactor fouling. For instance, contact between polyolefin particles, catalyst particles, and/or a reactor wall can lead to electrostatic charge generation within the fluidized bed reactor through triboelectric charging. This electrostatic charging (via triboelectric charging) can lead to particles becoming adhered to one another and/or the reactor wall, which may be referred to as fouling. Electrostatic charging (via triboelectric charging) can be detected, e.g., utilizing a static probe, as an electrostatic change in the fluidized bed of the FBT-GPP reactor, for instance.

Fouling can be detected as agglomerated particles that are removed from the FBT-GPP reactor, for instance. Sheeting is a known type of fouling. Sheeting can occur when particles, e.g., polyolefin particles, adhere to the reactor wall. Sheeting is undesired and can cause a number of issues, such as decreased productivity and/or reactor clogging, for instance.

Significant efforts have been put into reducing triboelectric charging and/or reactor fouling, including the use of chemical additives, modification to catalyst chemistry or catalyst particles, or adjustments to the reactor process conditions. However there continues to be a need to reduce triboelectric charging and/or reactor fouling in fluidized bed-type gas phase polymerization reactors. As used herein, “decreasing” refers to lessening, mitigating, and/or inhibiting, e.g., as compared to other polymerization processes having relatively greater triboelectric charging and/or reactor fouling.

Decreasing triboelectric charging can mean that the electrostatic charge of the polyolefin particles is lower than the electrostatic charge of polyolefin particles in a comparative method using an inert gas that is 100 vol % nitrogen gas in place of the argon gas/nitrogen gas mixture; and wherein the triboelectric charge of the polyolefin particles is measured on a sample of the polyolefin particles that have been removed from the FBT-GPP reactor wherein the measurement is done according to Charge Measurement Test Method described herein; or wherein the FBT-GPP reactor comprises a static probe and the triboelectric charge of the polyolefin particles is measured by the static probe. For instance, one or more embodiments provide that decreasing triboelectric charging means that the triboelectric charge of the polyolefin particles after 10 hours of fluidization by the argon gas/nitrogen gas mixture is lower by at least 10%, alternatively by at least 20%, alternatively at least 30%, relative to triboelectric charge of a comparative polyolefin particles that have been fluidized for 10 hours in a comparative method by using an inert gas that is 100 vol % nitrogen gas in place of the argon gas/nitrogen gas mixture. For instance, one or more embodiments provide that decreasing reactor fouling means that an amount of adhered polyolefin material, if any, in the FBT-GPP reactor after 10 hours is lower by at least 10%, alternatively by at least 20%, alternatively at least 30%, relative to an amount of adhered polyolefin material in the FBT-GPP reactor after 10 hours of a comparative method using an inert gas that is 100 vol % nitrogen gas in place of the argon gas/nitrogen gas mixture and wherein the amount of adhered polyolefin material equals any one of amounts (a) to (d): (a) the weight of polyolefin particles adhered to the distributor plate, (b) the weight of polyolefin particles adhered to the reactor wall, or (c the total of the weights (a) to (b); or (iii) both limitations (i) and (ii).

Decreasing reactor fouling can mean that an amount of adhered polyolefin material, if any, in the FBT-GPP reactor is lower relative to an amount of adhered polyolefin material in the FBT-GPP reactor of a comparative method using an inert gas that is 100 vol % nitrogen gas in place of the argon gas/nitrogen gas mixture.

Embodiments of the present disclosure are directed toward decreasing triboelectric charging and/or reactor fouling in fluidized bed-type gas phase polymerization reactors, as discussed further herein. As used herein, “decreasing fouling” can refer to delaying an onset of fouling and/or slowing a rate of fouling, where a rate of fouling is an increase of fouling material per unit time.

For the purposes of subject matter described herein and the claims thereto, the new numbering scheme for the Periodic Table Groups is used as described in Chemical and Engineering News, 63(5), pg. 27 (1985). Therefore, a “Group 4 metal” is an element from Group 4 of the Periodic Table, e.g., Ti, Zr, or Hf.

As used herein, the term “substituted” means that the referenced group possesses at least one moiety in place of one or more hydrogens in any position, the moieties selected from such groups as halogen radicals (esp., F, Cl, Br), hydroxyl groups, carbonyl groups, carboxyl groups, amine groups, phosphine groups, alkoxy groups, phenyl groups, naphthyl groups, C₁ to C₁₀ alkyl groups, C₂ to C₁₀ alkenyl groups, and combinations thereof. Examples of substituted alkyls and aryls includes, but are not limited to, acyl radicals, alkylamino radicals, alkoxy radicals, aryloxy radicals, alkylthio radicals, dialkylamino radicals, alkoxycarbonyl radicals, aryloxycarbonyl radicals, carbamoyl radicals, alkyl- and dialkyl-carbamoyl radicals, acyloxy radicals, acylamino radicals, arylamino radicals, and combinations thereof.

### Polymerization Conditions

As an example, polymerization conditions may be selected from any of the conditions described herein.

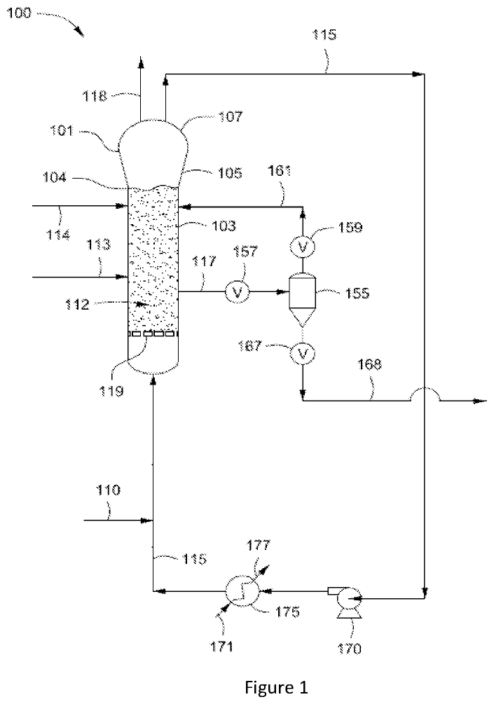

FIG. 1 depicts a schematic of an example gas phase polymerization system in accordance with a number of embodiments described herein. FIG. 1 illustrates a flow diagram of a gas phase polymerization system 100 for making polyolefins, according to one or more embodiments. The polymerization system 100 can include a reactor 101, e.g., a fluidized bed-type gas phase polymerization reactor, in fluid communication with one or more discharge tanks 155 (one shown), compressors 170 (one shown), and heat exchangers 175 (one shown). The polymerization system 100 can also include more than one reactor 101 arranged in series, parallel, or configured independent from the other reactors, each reactor having its own associated discharge tanks 155, compressors 170, and heat exchangers 175, or alternatively, sharing any one or more of the associated discharge tanks 155, compressors 170, and heat exchangers 175. For simplicity and ease of description, the polymerization system 100 will be further described in the context of a single reactor train.

One or more embodiments of the present disclosure utilize an argon gas/nitrogen gas mixture. The argon gas/nitrogen gas mixture may consist of from 5 volume percent (vol %) to no more than 65 vol % argon gas, from 95 vol % to no less than 10 vol % nitrogen gas, and from 0 vol % to no more than 5 vol % helium gas, wherein the sum of all these vol % equals 100 vol % of the argon gas/nitrogen gas mixture. All individual values and subranges are included; for example, the argon gas/nitrogen gas mixture may consist from a lower limit of 5 vol %, 15 vol %, or 25 vol % to an upper limit of 65 vol %, 60 vol %, or 50 vol % argon gas; from a lower limit of 10 vol %, 25 vol %, or 50 vol % to an upper limit of 95 vol %, 85 vol %, or 75% vol % nitrogen gas; and from a lower limit of 0 vol %, 0.5 vol %, or 1 vol % to an upper limit of 5 vol %, 4.5 vol %, or 4 vol % helium gas, where the sum of all these vol % (i.e. the argon gas vol %, the nitrogen vol %, and the helium vol %) equals 100 vol % of the argon gas/nitrogen gas mixture.

One or more embodiments provide that the argon gas/nitrogen gas mixture is: from 9 vol % to no more than 65 vol % argon gas; from 10 vol % to no more than 60 vol % argon gas; from 10 vol % to no more than 55 vol % argon gas; from 10 vol % to no more than 50 vol % argon gas; from 10 vol % to no more than 45 vol % argon gas; or from 10 vol % to no more than 35 vol % argon gas, where the sum the sum of the argon gas vol %, the nitrogen vol %, and the helium vol % equals 100 vol % of the argon gas/nitrogen gas mixture.

One or more embodiments provide that the argon gas/nitrogen gas mixture is: from 90 vol % to no less than 35 vol % nitrogen gas; from 90 vol % to no less than 40 vol % nitrogen gas; from 90 vol % to no less than 45 vol % nitrogen gas; from 90 vol % to no less than 50 vol % nitrogen gas; from 90 vol % to no less than 55 vol % nitrogen gas; or from 90 vol % to no less than 65 vol % nitrogen gas, where the sum the sum of the argon gas vol %, the nitrogen vol %, and the helium vol % equals 100 vol % of the argon gas/nitrogen gas mixture.

The argon gas/nitrogen gas mixture is fed to the reactor 101. The argon gas/nitrogen gas mixture can be fed upward through distributor plate 119 into a reaction zone of the reactor 101 to fluidize polyolefin particles in the reaction zone (i.e., form and/or maintain fluidized bed 112). The argon gas/nitrogen gas mixture can be introduced to the reactor 101 via one or more reactor inputs, e.g., below distributor plate 119. In other words, the argon gas/nitrogen gas mixture, as discussed herein, is entering the reactor 101 through the distributor plate 119; the argon gas/nitrogen gas mixture may enter the gas phase polymerization system by one or more inputs that may have various locations within the system. One or more embodiments provide that a number of other gasses, as known in the art, may be fed to the reactor 101.

One or more embodiments provide that the argon gas/nitrogen gas mixture is fed to the reactor 101 continuously. For instance, when the reactor 101 is operating in a steady-state polymerization condition, the argon gas/nitrogen gas mixture is fed to the reactor 101 continuously (e.g., at a rate that maintains the fluidized bed 112).

One or more embodiments provide that the argon gas/nitrogen gas mixture is fed to the reactor 101 intermittently, rather than continuously. For example, when the reactor 101 is operating at polymerization conditions, i.e., polyolefin product is being formed, the argon gas/nitrogen gas mixture can be fed to the reactor 101 for a fixed time interval. For instance, a fixed amount of the argon gas/nitrogen gas mixture can be fed to the reactor 101 for a fixed time interval. Various fixed time intervals and/or various fixed amounts of the argon gas/nitrogen gas mixture intermittently fed to the reactor 101 operating at polymerization conditions may be utilized for various applications. For instance, the fixed time interval may have a lower limit of 5 minutes, 15 minutes, or 30 minutes, among other values, and an upper limit of 12 hours, 8 hours, or 6 hours, among other values. The intermittent feeding of the argon gas/nitrogen gas mixture to the reactor 101 may be repeated differing numbers of times for differing applications.

When the argon gas/nitrogen gas mixture is fed to the reactor 101 intermittently, rather than continuously, the argon gas/nitrogen gas mixture can replace all or a portion of an inert fluidizing gas being fed to the reactor 101. Replacing all or a portion of the inert fluidizing gas being fed to the reactor 101 with the argon gas/nitrogen gas mixture can provide that the fluidized bed 112 is maintained, e.g., in a steady-state fluidization condition. Examples of the inert gas include nitrogen, among other inert gasses that may be utilized.

One or more embodiments provide that the intermittent feeding of the argon gas/nitrogen gas mixture to the reactor 101 is responsive to a processing parameter, e.g., a deviation from a steady-state polymerization process condition. Examples of processing parameters include an increase in static, e.g., at the reactor wall 103, or an increase in temperature, e.g., at the reactor wall 103, among other processing parameters. The increase in static may be detected with a static probe; the increase in temperature may be detected with a thermocouple. When the intermittent feeding of the argon gas/nitrogen gas mixture to the reactor 101 is responsive to a processing parameter, the argon gas/nitrogen gas mixture may be fed, e.g. the flow may be maintained, until the steady-state polymerization process condition is restored or partially restored, e.g., the static has been reduced to a threshold static level and/or the temperature has been reduced to a threshold temperature level.

The reactor 101 can include a cylindrical section, e.g., a reaction zone, defined by a wall 103, a transition section 105, and a velocity reduction zone or dome 107. As shown in FIG. 1, the reaction zone is disposed adjacent the transition section 105. The transition section 105 can expand from a first diameter that corresponds to the diameter of the reaction zone to a larger diameter adjacent the dome 107. As mentioned above, the location or junction at which the reaction connects to the transition section 105 is referred to as the “neck” or the “reactor neck” 104. The dome 107 has a bulbous shape. One or more cycle fluid lines 115 and vent lines 118 can be in fluid communication with the top head 107. The reactor 101 can include the fluidized bed 112 in fluid communication with the top head 107.

In general, the height to diameter ratio of the reaction zone, i.e. the cylindrical section defined by wall 103, can vary in the range of from about 2:1 to about 5:1. The range, of course, can vary to larger or smaller ratios and depends, at least in part, upon the desired production capacity and/or reactor dimensions. The cross-sectional area of the dome 107 is typically within the range of from about 2 to about 3 multiplied by the cross-sectional area of the reaction zone.

The velocity reduction zone or dome 107 has a larger inner diameter than the fluidized bed 112. As the name suggests, the velocity reduction zone 107 slows the velocity of the gas due to the increased cross-sectional area. This reduction in gas velocity allows particles entrained in the upward moving gas to fall back into the bed, allowing primarily only gas to exit overhead of the reactor 101 through the cycle fluid line 115. The cycle fluid recovered via line 115 can contain less than about 10% wt, less than about 8% wt, less than about 5% wt, less than about 4% wt, less than about 3% wt, less than about 2% wt, less than about 1% wt, less than about 0.5% wt, or less than about 0.2% wt of the particles entrained in fluidized bed 112.

The reactor feed via line 110 can be introduced to the polymerization system 100 at any point. For example, the reactor feed via line 110 can be introduced to the cylindrical section 103, the transition section 105, the velocity reduction zone 107, to any point within the cycle fluid line 115, or any combination thereof. Preferably, the reactor feed 110 is introduced to the cycle fluid in line 115 before or after the heat exchanger 175. In FIG. 1, the reactor feed via line 110 is depicted entering the cycle fluid in line 115 after the heat exchanger 175. The catalyst feed via line 113 can be introduced to the polymerization system 100 at any point. Preferably the catalyst feed via line 113 is introduced to the fluidized bed 112 within the reaction zone defined by wall 103. Various components, e.g., cocatalyst, may introduced to the reactor 101 by input 114, for example.

The cycle fluid via line 115 can be compressed in the compressor 170 and then passed through the heat exchanger 175 where heat can be exchanged between the cycle fluid and a heat transfer medium. For example, during normal operating conditions a cool or cold heat transfer medium via line 171 can be introduced to the heat exchanger 175 where heat can be transferred from the cycle fluid in line 115 to produce a heated heat transfer medium via line 177 and a cooled cycle fluid via line 115. In another example, during idling of the reactor 101 a warm or hot heat transfer medium via line 171 can be introduced to the heat exchanger 175 where heat can be transferred from the heat transfer medium to the cycle fluid in line 115 to produce a cooled heat transfer medium via line 117 and a heated cycle fluid via line 115. The terms “cool heat transfer medium” and “cold heat transfer medium” refer to a heat transfer medium having a temperature less than the fluidized bed 112 within the reactor 101. The terms “warm heat transfer medium” and “hot heat transfer medium” refer to a heat transfer medium having a temperature greater than the fluidized bed 112 within the reactor 101. The heat exchanger 175 can be used to cool the fluidized bed 112 or heat the fluidized bed 112 depending on the particular operating conditions of the polymerization system 100, e.g. start-up, normal operation, idling, and shut down. Illustrative heat transfer mediums can include, but are not limited to, water, air, glycols, or the like. It is also possible to locate the compressor 170 downstream from the heat exchanger 175 or at an intermediate point between several heat exchangers 175.

After cooling, all or a portion of the cycle fluid via line 115 can be returned to the reactor 101. The cooled cycle fluid in line 115 can absorb the heat of reaction generated by the polymerization reaction. The heat transfer medium in line 171 can be used to transfer heat to the cycle fluid in line 115 thereby introducing heat to the polymerization system 100 rather than removing heat therefrom. The heat exchanger 175 can be of any type of heat exchanger. Illustrative heat exchangers can include, but are not limited to, shell and tube, plate and frame, U-tube, and the like. For example, the heat exchanger 175 can be a shell and tube heat exchanger where the cycle fluid via line 115 can be introduced to the tube side and the heat transfer medium can be introduced to the shell side of the heat exchanger 175. If desired, several heat exchangers can be employed, in series, parallel, or a combination of series and parallel, to lower or increase the temperature of the cycle fluid in stages.

Preferably, the cycle gas via line 115 is returned to the reactor 101 and to the fluidized bed 112 through fluid distributor plate (“plate”) 119. The plate 119 is preferably installed at the inlet to the reactor 101 to prevent polyolefin particles from settling out and agglomerating into a solid mass and to prevent liquid accumulation at the bottom of the reactor 101, e.g., a bottom zone, as well to facilitate easy transitions between processes which contain liquid in the cycle stream 115 and those which do not and vice versa. Although not shown, the cycle gas via line 115 can be introduced into the reactor 101 through a deflector disposed or located intermediate an end of the reactor 101 and the distributor plate 119.

The catalyst feed via line 113 can be introduced to the fluidized bed 112 within the reactor 101 through one or more injection nozzles (not shown) in fluid communication with line 113. The catalyst feed may be introduced as pre-formed particles in one or more liquid carriers (i.e. a catalyst slurry). Suitable liquid carriers can include mineral oil and/or liquid or gaseous hydrocarbons including, but not limited to, propane, butane, isopentane, hexane, heptane octane, or mixtures thereof. A gas that is inert to the catalyst slurry such as, for example, nitrogen, can also be used to carry the catalyst slurry into the reactor 101. In one example, the catalyst can be a dry powder. In another example, the catalyst can be dissolved in a liquid carrier and introduced to the reactor 101 as a solution. The catalyst via line 113 can be introduced to the reactor 101 at a rate sufficient to maintain polymerization of the monomer(s) therein.

Fluid via line 161 can be separated from a polymer product recovered via line 117 from the reactor 101. The fluid can include unreacted monomer(s), hydrogen, induced condensing agent(s) (“ICA(s)”), and/or inerts. The separated fluid can be introduced to the reactor 101. The separated fluid can be introduced to the recycle line 115 (not shown). The separation of the fluid can be accomplished when fluid and product leave the reactor 101 and enter the product discharge tank 155 through valve 157, which can be, for example, a ball valve designed to have minimum restriction to flow when opened. Positioned above and below the product discharge tank 155 can be conventional valves 159, 167. The valve 167 allows passage of product therethrough. For example, to discharge the polyolefin product from the reactor 101, valve 157 can be opened while valves 159, 167 are in a closed position. Product and fluid enter the product discharge tank 155. Valve 157 is closed and the product is allowed to settle in the product discharge tank 155. Valve 159 is then opened permitting fluid to flow via line 161 from the product discharge tank 155 to the reactor 101. Valve 159 can then be closed and valve 167 can be opened and any product in the product discharge tank 155 can flow into and be recovered via line 168. Valve 167 can then be closed. Although not shown, the product via line 168 can be introduced to a plurality of purge bins or separation units, in series, parallel, or a combination of series and parallel, to further separate gases and/or liquids from the product. The particular timing sequence of the valves 157, 159, 167, can be accomplished by use of conventional programmable controllers which are well known in the art.

One or more embodiments provide that the FBT-GPP reactor comprises, in sequential fluid communication, a bottom zone, the distributor plate, the wall defining the reaction zone, a wall defining a velocity reduction zone, a recycle line, and a compressor, lines for inletting feeds, and an outlet for removing polyolefin particles, and optionally a static probe; wherein the recycle line fluidly connects the velocity reduction zone to the compressor and the compressor to the bottom zone.

Another preferred product discharge system which can be alternatively employed is that disclosed in U.S. Pat. No. 4,621,952. Such a system employs at least one (parallel) pair of tanks comprising a settling tank and a transfer tank arranged in series and having the separated gas phase returned from the top of the settling tank to a point in the reactor near the top of the fluidized bed.

The reactor 101 can be equipped with one or more vent lines 118 to allow venting the bed during start up, idling, and/or shut down. The reactor 101 can be free from the use of stirring and/or wall scraping. The cycle line 115 and the elements therein (compressor 170, heat exchanger 175) can be smooth surfaced and devoid of unnecessary obstructions so as not to impede the flow of cycle fluid or entrained particles.

The conditions for polymerizations vary depending upon the monomers, catalysts, catalyst systems, and equipment availability. The specific conditions are known or readily derivable by those skilled in the art. For example, the temperatures can be within the range of from about 70° C. to about 120° C., about 75° C. to about 120° C., and about 80° C. to about 110° C. Pressures can be within the range of from about 10 kPag to about 10,000 kPag, such as about 500 kPag to about 5,000 kPag, or about 1,000 kPag to about 2,200 kPag, for example.

The amount of hydrogen in the reactor 101 can be expressed as a mole ratio relative to the total polymerizable monomer, for example, ethylene or a blend of ethylene and one or more comonomers. The amount of hydrogen used in the polymerization process can be an amount necessary to achieve the desired flow index of the polyolefin product. The mole ratio of hydrogen to total monomer (H₂:monomer) can be ≥ about 0.0001, e.g., ≥ about 0.0005, ≥ about 0.001, ≥ about 0.01, ≥ about 0.1, ≥ about 1.0, ≥ about 3.0, or about 5.0. Additionally or alternatively, the mole ratio of hydrogen to total monomer (H₂:monomer) can be ≤ about 10, e.g., ≤ about 5.0, ≤ about 3.0, ≤ about 1.0, ≤ about 0.1, ≤ about 0.01, ≤ about 0.001, or ≤ about 0.0005. Ranges of the concentration of the continuity aid that are expressly disclosed comprise ranges formed by pairs of any of the above-enumerated values, e.g., about 0.0001 to about 10.0, about 0.0005 to about 5.0, about 0.0005 to 0.001, about 0.001 to about 3.0, about 0.01 to about 1.0, etc., Expressed another way, the amount of hydrogen in the reactor at any time can range to up to 5,000 ppm, or up to 4,000 ppm, or up to 3,000 ppm, or between 50 ppm and 5,000 ppm, or between 50 ppm and 2,000 ppm. The amount of hydrogen in the reactor can range from a low of about 1 ppm, about 50 ppm, or about 100 ppm to a high of about 400 ppm, about 800 ppm, about 1,000 ppm, about 1,500 ppm, about 2,000 ppm, about 5,000 ppm, or about 10,000 ppm, with suitable ranges comprising the combination of any two values. The ratio of hydrogen to total monomer (H₂:monomer) can be about 0.00001:1 to about 2:1, about 0.005:1 to about 1.5:1, or about 0.0001:1 to about 1:1.

Other illustrative techniques that can also be used are described in U.S. Pat. Nos. 4,994,534, 5,200,477, and 4,803,251; as well as condensing mode operation, such as described in U.S. Pat. Nos. 4,543,399 and 4,588,790.

Additional reactor details and means for operating the reactor can be as described in, for example, U.S. Pat. Nos. 3,709,853; 4,003,712; 4,011,382; 4,302,566; 4,543,399; 4,882,400; 5,352,749; and 5,541,270; EP 0802202.

### Startup Conditions

Prior to steady-state polymerization conditions, as previously discussed herein, being utilized for gas phase polymerization system 100, startup conditions may be utilized. As used herein, “startup conditions” refer to conditions utilized where polyolefin product is not actively being produced. One or more embodiments provide that startup conditions indicate that no polymerization catalyst is being fed to the reactor 101, e.g., while the startup gas is being fed to the reactor. One or more embodiments provide that startup conditions can include loading the reactor 101 with a seedbed of granular resin, which may be utilized to form a fluidized bed while no polymerization catalyst is being fed to the reactor, for instance.

One or more embodiments provide that a startup gas is fed to the reactor 101. For instance, the startup gas can be fed upward through distributor plate 119 into a reaction zone of the reactor 101. Feeding the startup gas to the reactor 101 can provide that the reactor has a startup gas environment, e.g., the reactor is absent of gasses other than the startup gas. Desirably, utilizing the startup gas can provide lower static charge in the reactor 101, as compared to a similar reactor having similar conditions but not utilizing the startup gas, among other benefits. Advantageously, this relatively lower static charge can provide for relatively quicker startups.

Embodiments of the present disclosure provide that the startup gas may consist of from 80 volume percent (vol %) to 100 vol % argon gas and 0 vol % to 20% nitrogen gas, wherein the sum of all these vol % equals 100 vol % of the startup gas. All individual values and subranges are included; for example, the startup gas may consist from a lower limit of 80 vol %, 85 vol %, or 90 vol % to an upper limit of 100 vol %, 98 vol %, or 96 vol % argon gas; and from a lower limit of 0 vol %, 2 vol %, or 4 vol % to an upper limit of 20 vol %, 15 vol %, or 10 vol % nitrogen gas, wherein the sum of all these vol % equals 100 vol % of the startup gas.

One or more embodiments provide that the startup is fed to the reactor 101 continuously. In other words, a startup gas environment, e.g., the reactor is absent of gasses other than the startup gas, may be maintained for a startup interval. The startup interval can have various values for different applications. For instance, the startup interval can be from a lower limit of 5 minutes, 15 minutes, or 30 minutes, among other values, and an upper limit of 12 hours, 8 hours, or 6 hours, among other values.

One or more embodiments provide that the startup interval may continue until a startup parameter value is obtained. For example, the startup interval may continue until a startup static threshold value is obtained. The static threshold value can have different values for different applications.

Embodiments provide that other startup up conditions, as know in the art, may be utilized.

### Catalyst Compositions

The catalyst composition can be or include any catalyst or combination of catalysts. Illustrative catalysts can include, but are not limited to, Ziegler-Natta catalysts, chromium-based catalysts, metallocene catalysts and other catalytic compounds containing uniform polymerization sites single-site catalysts including Group 15-containing catalysts, bimetallic catalysts, and mixed catalysts. The catalyst can also include AlCl₃, cobalt, iron, palladium, chromium/chromium oxide or “Phillips” catalysts. Any catalyst can be used alone or in combination with any other catalyst. Catalyst compositions useful olefin polymerizations where the catalyst is in spray-dried form may be particularly benefitted from the methods described herein.

A first and/or second catalyst composition may comprise a metallocene catalyst component. Metallocene catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes π-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the metallocene compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4 or +5; or may be +2, +3 or +4. The groups bound to the metal atom “M” are such that the compounds described below in the structures and structures are electrically neutral, unless otherwise indicated. The Cp ligand(s) forms at least one chemical bond with the metal atom M to form the “metallocene catalyst component.” The Cp ligands are distinct from the leaving groups bound to metal atom M in that they are not highly susceptible to substitution/abstraction reactions.

The metallocene catalyst component may include compounds represented by Structure (I):

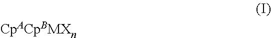

where M is as described above; each X is chemically bonded to M; each Cp group is chemically bonded to M; and n is 0 or an integer from 1 to 4. In some embodiments, n is either 1 or 2.

The ligands represented by Cp^{A} and Cp^{B} in Structure (I) may be the same or different cyclopentadienyl ligands or ligands isolobal to cyclopentadienyl, either or both of which may contain heteroatoms and either or both of which may be substituted by a group R. For example, Cp^{A} and Cp^{B} may be independently selected from cyclopentadienyl, indenyl, tetrahydroindenyl, fluorenyl, and substituted derivatives of each.

Independently, each Cp^{A} and Cp^{B} of Structure (I) may be unsubstituted or substituted with any one or combination of substituent groups R. Non-limiting examples of substituent groups R as used in Structure (I) include hydrogen radicals, hydrocarbyls, lower hydrocarbyls, substituted hydrocarbyls, heterohydrocarbyls, alkyls, lower alkyls, substituted alkyls, heteroalkyls, alkenyls, lower alkenyls, substituted alkenyls, heteroalkenyls, alkynyls, lower alkynyls, substituted alkynyls, heteroalkynyls, alkoxys, lower alkoxys, aryloxys, hydroxyls, alkylthios, lower alkyl thios, arylthios, thioxys, aryls, substituted aryls, heteroaryls, aralkyls, aralkylenes, alkaryls, alkarylenes, halides, haloalkyls, haloalkenyls, haloalkynyls, heteroalkyls, heterocycles, heteroaryls, heteroatom-containing groups, silyls, boryls, phosphinos, phosphines, aminos, amines, cycloalkyls, acyls, aroyls, alkylthiols, dialkylamines, alkylamidos, alkoxycarbonyls, aryloxycarbonyls, carbamoyls, alkyl- and dialkyl-carbamoyls, acyloxys, acylaminos, aroylaminos, and combinations thereof.

More particular non-limiting examples of alkyl substituents R associated with Structure (I) include methyl, ethyl, propyl, butyl, pentyl, hexyl, cyclopentyl, cyclohexyl, benzyl, phenyl, methylphenyl, and tert-butylphenyl groups and the like, including all their isomers, for example tertiary-butyl, isopropyl, and the like. Other possible radicals include substituted alkyls and aryls such as, for example, fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris (trifluoromethyl)silyl, methylbis (difluoromethyl)silyl, bromomethyldimethylgermyl and the like; and disubstituted boron radicals including dimethylboron for example; and disubstituted Group 15 radicals including dimethylamine, dimethylphosphine, diphenylamine, methylphenylphosphine, Group 16 radicals including methoxy, ethoxy, propoxy, phenoxy, methylsulfide and ethylsulfide. Other substituents R include olefins, such as, but not limited to, olefinically unsaturated substituents including vinyl-terminated ligands, for example 3-butenyl, 2-propenyl, 5-hexenyl, and the like. In some embodiments, at least two R groups, for example, two adjacent R groups, are joined to form a ring structure having from 3 to 30 atoms selected from carbon, nitrogen, oxygen, phosphorous, silicon, germanium, aluminum, boron and combinations thereof. Also, a substituent R group, such as 1-butanyl, may form a bonding association to the element M.

Each X in Structure (I), above, and Structures (II)-(Va-d), below, is independently selected from: for example, halogen ions, hydrides, hydrocarbyls, lower hydrocarbyls, substituted hydrocarbyls, heterohydrocarbyls, alkyls, lower alkyls, substituted alkyls, heteroalkyls, alkenyls, lower alkenyls, substituted alkenyls, heteroalkenyls, alkynyls, lower alkynyls, substituted alkynyls, heteroalkynyls, alkoxys, lower alkoxys, aryloxys, hydroxyls, alkylthios, lower alkyls thios, arylthios, thioxys, aryls, substituted aryls, heteroaryls, aralkyls, aralkylenes, alkaryls, alkarylenes, halides, haloalkyls, haloalkenyls, haloalkynyls, heteroalkyls, heterocycles, heteroaryls, heteroatom-containing groups, silyls, boryls, phosphinos, phosphines, aminos, amines, cycloalkyls, acyls, aroyls, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof. In some embodiments, X is a C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₁₈ alkylaryloxys, C₁ to C₁₂ fluoroalkyls, C₆ to C₁₂ fluoroaryls, or C₁ to C₁₂ heteroatom-containing hydrocarbons, and substituted derivatives thereof. X may be selected from hydride, halogen ions, C₁ to C₆ alkyls, C₂ to C₆ alkenyls, C₇ to C₁₃ alkylaryls, C₁ to C₆ alkoxys, C₆ to C₁₄ aryloxys, C₇ to C₁₆ alkylaryloxys, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls, or C₇ to C₁₈ fluoroalkylaryls; or X may be selected from hydride, chloride, fluoride, methyl, phenyl, phenoxy, benzoxy, tosyl, fluoromethyls, and fluorophenyls; or X may be selected from C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls and C₁ to C₁₂ heteroatom-containing alkyls, C₁ to C₁₂ heteroatom-containing aryls, and C₁ to C₁₂ heteroatom-containing alkylaryls; or X may be selected from chloride, fluoride, C₁ to C₆ alkyls, C₂ to C₆ alkenyls, C₇ to C₁₈ alkylaryls, halogenated C₁ to C₆ alkyls, halogenated C₂ to C₆ alkenyls, and halogenated C₇ to C₁₈ alkylaryls; or X may be selected from fluoride, methyl, ethyl, propyl, phenyl, methylphenyl, dimethylphenyl, trimethylphenyl, fluoromethyls (mono-, di- and trifluoromethyls), and fluorophenyls (mono-, di-, tri-, tetra- and pentafluorophenyls). In some embodiments, at least one X is a halogenated aryloxy group or a derivative thereof. For example, at least one X may be a pentafluorophenoxy group.

A metallocene catalyst component of the first and/or second catalyst composition may include those metallocenes of Structure (I) where Cp^{A} and Cp^{B} are bridged to each other by at least one bridging group, (A), such that the structure is represented by Structure (II):

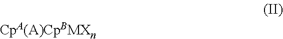

These bridged compounds represented by Structure (II) are known as “bridged metallocenes.” Cp^{A}, Cp^{B}, M, X and n in Structure (II) are as defined above for Structure (I); and wherein each Cp ligand is chemically bonded to M, and (A) is chemically bonded to each Cp. Non-limiting examples of bridging group (A) include divalent alkyls, divalent lower alkyls, divalent substituted alkyls, divalent heteroalkyls, divalent alkenyls, divalent lower alkenyls, divalent substituted alkenyls, divalent heteroalkenyls, divalent alkynyls, divalent lower alkynyls, divalent substituted alkynyls, divalent heteroalkynyls, divalent alkoxys, divalent lower alkoxys, divalent aryloxys, divalent alkylthios, divalent lower alkyl thios, divalent arylthios, divalent aryls, divalent substituted aryls, divalent heteroaryls, divalent aralkyls, divalent aralkylenes, divalent alkaryls, divalent alkarylenes, divalent haloalkyls, divalent haloalkenyls, divalent haloalkynyls, divalent heteroalkyls, divalent heterocycles, divalent heteroaryls, divalent heteroatom-containing groups, divalent hydrocarbyls, divalent lower hydrocarbyls, divalent substituted hydrocarbyls, divalent heterohydrocarbyls, divalent silyls, divalent boryls, divalent phosphinos, divalent phosphines, divalent aminos, divalent amines, divalent ethers, and divalent thioethers. Additional non-limiting examples of bridging group A include divalent hydrocarbon groups containing at least one Group 13 to 16 atom, such as but not limited to at least one of a carbon, oxygen, nitrogen, silicon, aluminum, boron, germanium and tin atom and combinations thereof; wherein the heteroatom may also be C₁ to C₁₂ alkyl or aryl substituted to satisfy neutral valency. The bridging group (A) may also contain substituent groups R as defined above for Structure (I) including halogen radicals and iron. More particular non-limiting examples of bridging group (A) are represented by C to C₆ alkylenes, substituted C₁ to C₆ alkylenes, oxygen, sulfur, R′₂C═, R′₂Si═, —Si(R′)₂Si(R′₂)—, R′₂Ge═, R′P═ (wherein “=” represents two chemical bonds), where R′ is independently selected from hydride, hydrocarbyl, substituted hydrocarbyl, halocarbyl, substituted halocarbyl, hydrocarbyl-substituted organometalloid, halocarbyl-substituted organometalloid, disubstituted boron, disubstituted Group 15 atoms, substituted Group 16 atoms, and halogen radical; and wherein two or more R′ may be joined to form a ring or ring system. In some embodiments, the bridged metallocene catalyst component of Structure (II) has two or more bridging groups (A).

Other non-limiting examples of bridging group (A), in Structure (II), include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties wherein the Si atom is replaced by a Ge or a C atom; dimethylsilyl, diethylsilyl, dimethylgermyl and diethylgermyl.

In some embodiments, bridging group (A), in Structure (II), may also be cyclic, comprising, 4 to 10 ring members or 5 to 7 ring members. The ring members may be selected from the elements mentioned above, or from one or more of B, C, Si, Ge, N and O. Non-limiting examples of ring structures which may be present as or part of the bridging moiety are cyclobutylidene, cyclopentylidene, cyclohexylidene, cycloheptylidene, cyclooctylidene and the corresponding rings where one or two carbon atoms are replaced by at least one of Si, Ge, N and O, in particular, Si and Ge. The bonding arrangement between the ring and the Cp groups may be either cis-, trans-, or a combination thereof.

The cyclic bridging groups (A) may be saturated or unsaturated and/or carry one or more substituents and/or be fused to one or more other ring structures. If present, the one or more substituents may be a hydrocarbyl (e.g., alkyl such as methyl) or halogen (e.g., F, Cl). The one or more Cp groups which the above cyclic bridging moieties may optionally be fused to may be saturated or unsaturated and are selected from those having 4 to 10, more particularly 5, 6, or 7 ring members (selected from C, N, O and S in a particular embodiment), such as, for example, cyclopentyl, cyclohexyl and phenyl. Moreover, these ring structures may themselves be fused such as, for example, in the case of a naphthyl group. Moreover, these (optionally fused) ring structures may carry one or more substituents. Illustrative, non-limiting examples of these substituents are hydrocarbyl (particularly alkyl) groups and halogen atoms.

In some embodiments, the ligands Cp^{A} and Cp^{B} of Structures (I) and (II) may be different from each other, or in other embodiments may be the same as each other.

A metallocene catalyst component of the first and/or second catalyst composition may include mono-ligand metallocene compounds, such as, monocyclopentadienyl catalyst components, as described in WO 93/08221.

A metallocene catalyst component may be an unbridged “half sandwich” metallocene represented by Structure (III):

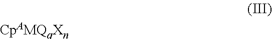

where Cp^{A} is defined as for the Cp groups in Structure (I) and is a ligand that is bonded to M; each Q is independently bonded to M; Q is also bound to Cp^{A} in one embodiment; X is a leaving group as described above in Structure (I); n ranges from 0 to 3, or is 1 or 2; q ranges from 0 to 3, or is 1 or 2.

Cp^{A} may be selected from cyclopentadienyl, indenyl, tetrahydroindenyl, fluorenyl, substituted version thereof, and combinations thereof. In Structure (III), Q may be selected from ROO, RO—, R(O)—, —NR—, —CR₂—, —S—, —NR₂, —CR₃, —SR, —SiR₃, —PR₂, —H, and substituted and unsubstituted aryl groups, wherein R is selected from hydrocarbyls, lower hydrocarbyls, substituted hydrocarbyls, heterohydrocarbyls, alkyls, lower alkyls, substituted alkyls, heteroalkyls, alkenyls, lower alkenyls, substituted alkenyls, heteroalkenyls, alkynyls, lower alkynyls, substituted alkynyls, heteroalkynyls, alkoxys, lower alkoxys, aryloxys, hydroxyls, alkylthios, lower alkyls thios, arylthios, thioxys, aryls, substituted aryls, heteroaryls, aralkyls, aralkylenes, alkaryls, alkarylenes, halides, haloalkyls, haloalkenyls, haloalkynyls, heteroalkyls, heterocycles, heteroaryls, heteroatom-containing groups, silyls, boryls, phosphinos, phosphines, aminos, amines, cycloalkyls, acyls, aroyls, alkylthiols, dialkylamines, alkylamidos, alkoxycarbonyls, aryloxycarbonyls, carbamoyls, alkyl- and dialkyl-carbamoyls, acyloxys, acylaminos, aroylaminos, and combinations thereof. R may be selected from C₁ to C₆ alkyls, C₆ to C₁₂ aryls, C₁ to C₆ alkylamines, C₆ to C₁₂ alkylarylamines, C₁ to C₆ alkoxys, C₆ to C₁₂ aryloxys, and the like. Non-limiting examples of Q include C₁ to C₁₂ carbamates, C₁ to C₁₂ carboxylates (e.g., pivalate), C₂ to C₂₀ allyls, and C₂ to C₂₅ heteroallyl moieties.

It is contemplated that the metallocene catalysts components described above include their structural or optical or enantiomeric isomers (racemic mixture), and may be a pure enantiomer in one embodiment. As used herein, a single, bridged, asymmetrically substituted metallocene catalyst component having a racemic and/or meso isomer does not, itself, constitute at least two different bridged, metallocene catalyst components. The “metallocene catalyst compound”, also referred to herein as the metallocene catalyst component” may comprise any combination of any “embodiment” described herein.

The “Group 15-containing catalyst” useful as first and/or second catalyst compositions may include Group 3 to Group 12 metal complexes, wherein the metal is 2 to 8 coordinate, the coordinating moiety or moieties including at least two Group 15 atoms, and up to four Group 15 atoms. For example, the Group 15-containing catalyst component can be a complex of a Group 4 metal and from one to four ligands such that the Group 4 metal is at least 2 coordinate, the coordinating moiety or moieties including at least two nitrogens. Representative Group 15-containing compounds are disclosed in WO Publication No. WO 99/01460; European Publication Nos. EP0893454A1; EP 0894005A1; U.S. Pat. Nos. 5,318,935; 5,889,128; 6,333,389; and 6,271,325.

The Group 15-containing catalyst components may include Group 4 imino-phenol complexes, Group 4 bis (amide) complexes, and Group 4 pyridyl-amide complexes that are active towards olefin polymerization to any extent.

The Group 15-containing catalyst component may be represented by Structures (VII) and (VIII):

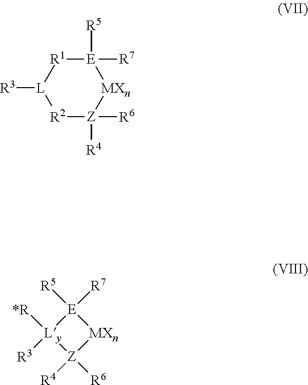

wherein E and Z are Group 15 elements independently selected from nitrogen and phosphorus in one embodiment; and nitrogen in a more particular embodiment, L and L′ may or may not form a bond with M; y is an integer ranging from 0 to 2 (when y is 0, group L′, *R and R³ are absent); M is selected from Group 3 to Group 5 atoms, or Group 4 atoms, or selected from Zr and Hf; n is an integer ranging from 1 to 4, or from 2 to 3; and each X is as defined above.

In Structure (VII), L may be selected from Group 15 atoms, Group 16 atoms, Group 15-containing hydrocarbylenes, and a Group 16-containing hydrocarbylenes; wherein R³ is absent when L is a Group 16 atom. In some embodiments, when R³ is absent, L is selected from heterocyclic hydrocarbylenes; or L is selected from nitrogen, phosphorous, anilinyls, pyridyls, quinolyls, pyrrolyls, pyrimidyls, purinyls, imidazyls, indolyls; C₁ to C₆ alkyl substituted groups selected from anilinyls, pyridyls, quinolyls, pyrrolyls, pyrimidyls, purinyls, imidazyls, and indolyls; C₁ to C₆ alkylamine substituted groups selected from anilinyls, pyridyls, quinolyls, pyrrolyls, pyrimidyls, purinyls, imidazyls, indolyls; amine substituted anilinyls, pyridyls, quinolyls, pyrrolyls, pyrimidyls, purinyls, imidazyls, and indolyls; hydroxy substituted groups selected from anilinyls, pyridyls, quinolyls, pyrrolyls, pyrimidyls, purinyls, imidazyls, and indolyls; methyl-substituted phenylamines, substituted derivatives thereof, and chemically bonded combinations thereof.

In Structure (VIII), L′ is selected from Group 15 atoms, Group 16 atoms, and Group 14 atoms in one embodiment; and selected from Group 15 and Group 16 atoms in a more particular embodiment; and is selected from groups as defined by L above in yet a more particular embodiment, wherein “EZL” and “EZL” may be referred to as a “ligand”, the EZL and EZL′ ligands comprising the R* and R¹-R⁷ groups;

In Structure (VII), R¹ and R² are independently: divalent bridging groups selected from alkylenes, arylenes, heteroatom containing alkylenes, heteroatom containing arylenes, substituted alkylenes, substituted arylenes and substituted heteroatom containing alkylenes, wherein the heteroatom is selected from silicon, oxygen, nitrogen, germanium, phosphorous, boron and sulfur; or is selected from C₁ to C₂₀ alkylenes, C₆ to C₁₂ arylenes, heteroatom-containing C₁ to C₂₀ alkylenes, and heteroatom-containing C₆ to C₁₂ arylenes; or is selected from —CH₂—, —C(CH₃)₂—, —C(C₆H₅)₂—, —CH₂CH₂—, —CH₂CH₂CH₂—, —Si(CH₃)₂—, —Si(C₅H₅)₂—, —C₆H₁₀—, —C₆H₄—, and substituted derivatives thereof, the substitutions including C₁ to C₄ alkyls, phenyl, and halogen radicals.

In Structure (VIII), R³ may be absent; or may be a group selected from hydrocarbyl groups, hydrogen radical, halogen radicals, and heteroatom-containing groups; or may be selected from linear alkyls, cyclic alkyls, and branched alkyls having 1 to 20 carbon atoms.

In Structure (VIII), *R may be absent; or may be a group selected from hydrogen radical, Group 14 atom containing groups, halogen radicals, and heteroatom-containing groups.

In Structures (VII) and (VIII), R⁴ and R⁵ are independently: groups selected from alkyls, aryls, substituted aryls, cyclic alkyls, substituted cyclic alkyls, cyclic arylalkyls, substituted cyclic arylalkyls, and multiple ring systems, wherein each group has up to 20 carbon atoms, or between 3 and 10 carbon atoms; or is selected from C₁ to C₂₀ alkyls, C₁ to C₂₀ aryls, C₁ to C₂₀ arylalkyls, and heteroatom-containing groups (for example PR₃, where R is an alkyl group).

In Structures (VII) and (VIII), R⁶ and R⁷ are independently: absent; or are groups selected from hydrogen radicals, halogen radicals, heteroatom-containing groups and hydrocarbyls; or are selected from linear, cyclic and branched alkyls having from 1 to 20 carbon atoms; wherein R¹ and R² may be associated with one another, and/or R⁴ and R⁵ may be associated with one another as through a chemical bond.

Described yet more particularly, the Group 15-containing catalyst component can be described as the embodiments shown in Structures (IX), (X) and (XI) (where “N” is nitrogen):

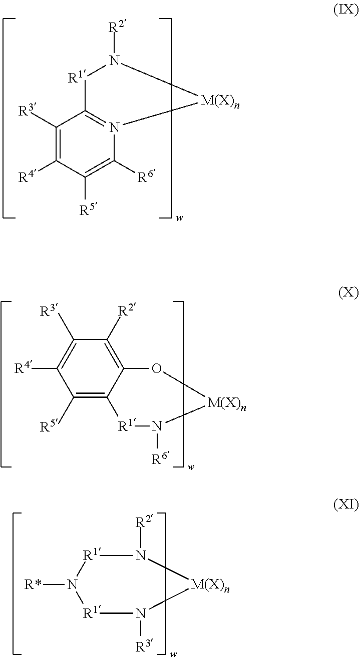

wherein Structure (IX) represents pyridyl-amide structures, Structure (X) represents imino-phenol structures, and Structure (XI) represents bis (amide) structures. In these Structures, w is an integer from 1 to 3, or is 1 or 2, or is 1 in some embodiments. M is a Group 3 to Group 13 element, or a Group 3 to Group 6 element, or Group 4 element in some embodiments. Each X is independently selected from hydrogen radicals, halogen ions (desirably, anions of fluorine, chlorine, and bromine); C₁ to C₆ alkyls; C₁ to C₆ fluoroalkyls, C₆ to C₁₂ aryls; C₆ to C₁₂ fluoroalkyls, C₁ to C₆ alkoxys, C₆ to C₁₂ aryloxys, and C₇ to C₁₈ alkylaryloxys. n is an integer ranging from 0 to 4, or from 1 to 3, or from 2 to 3, or is 2 in some embodiments.

Further, in Structures (IX), (X), and (XI), R^{1′} may be selected from hydrocarbylenes and heteroatom-containing hydrocarbylenes, or may be selected from —SiR₂—, alkylenes, arylenes, alkenylenes and substituted alkylenes, substituted alkenylenes and substituted arylenes; or may be selected from —SiR₂—, C₁ to C₆ alkylenes, C₆ to C₁₂ arylenes, C₁ to C₆ substituted alkylenes and C₆ to C₁₂ substituted arylenes, wherein R is selected from C₁ to C₆ alkyls and C₆ to C₁₂ aryls.

Further, in Structures (IX), (X), and (XI), R^{1′} R^{2′}, R^{3′}, R^{4′}, R^{5′}, R^{6′} and R′ are independently selected from hydride, C₁ to C₁₀ alkyls, C₆ to C₁₂ aryls, C₆ to C₁₈ alkylaryls, C₄ to C₁₂ heterocyclic hydrocarbyls, substituted C₁ to C₁₀ alkyls, substituted C₆ to C₁₂ aryls, substituted C₆ to C₁₈ alkylaryls, and substituted C₄ to C₁₂ heterocyclic hydrocarbyls and chemically bonded combinations thereof. In some embodiments, R* is absent. In some embodiments, R*—N represents a nitrogen containing group or ring such as a pyridyl group or a substituted pyridyl group that is bridged by the R^{1′} groups. In some embodiments, R*—N is absent, and the R^{1′} groups form a chemical bond to one another.

In some embodiments of Structures (IX), (X), and (XI), R^{1′} is selected from methylene, ethylene, 1-propylene, 2-propylene, ═Si(CH₃)₂, ═Si(phenyl)₂, —CH═, —C(CH₃)═, —C(phenyl)₂-, —C(phenyl)= (wherein “=” represents two chemical bonds), and the like.

In a particular embodiment of Structure (X), R^{2′} and R^{4′} are selected from 2-methylphenyl, 2-n-propylphenyl, 2-iso-propylphenyl, 2-iso-butylphenyl, 2-tert-butylphenyl, 2-fluorophenyl, 2-chlorophenyl, 2-bromophenyl, 2-methyl-4-chlorophenyl, 2-n-propyl-4-chlorophenyl, 2-iso-propyl-4-chlorophenyl, 2-iso-butyl-4-chlorophenyl, 2-tert-butyl-4-chlorophenyl, 2-methyl-4-fluorophenyl, 2-n-propyl-4-fluorophenyl, 2-iso-propyl-4-fluorophenyl, 2-iso-butyl-4-fluorophenyl, 2-tert-butyl-4-fluorophenyl, 2-methyl-4-bromophenyl, 2-n-propyl-4-bromophenyl, 2-iso-propyl-4-bromophenyl, 2-iso-butyl-4-bromophenyl, 2-tert-butyl-4-bromophenyl, and the like.

In some embodiments of Structures (IX) and (XI), R^{2′} and R^{3′} are selected from 2-methylphenyl, 2-n-propylphenyl, 2-iso-propylphenyl, 2-iso-butylphenyl, 2-tert-butylphenyl, 2-fluorophenyl, 2-chlorophenyl, 2-bromophenyl, 4-methylphenyl, 4-n-propylphenyl, 4-iso-propylphenyl, 4-iso-butylphenyl, 4-tert-butylphenyl, 4-fluorophenyl, 4-chlorophenyl, 4-bromophenyl, 6-methylphenyl, 6-n-propylphenyl, 6-iso-propylphenyl, 6-iso-butylphenyl, 6-tert-butylphenyl, 6-fluorophenyl, 6-chlorophenyl, 6-bromophenyl, 2,6-dimethylphenyl, 2,6-di-n-propylphenyl, 2,6-di-isopropylphenyl, 2,6-di-isobutylphenyl, 2,6-di-tert-butylphenyl, 2,6-difluorophenyl, 2,6-dichlorophenyl, 2,6-dibromophenyl, 2,4,6-trimethylphenyl, 2,4,6-tri-n-propylphenyl, 2,4,6-tri-iso-propylphenyl, 2,4,6-tri-iso-butylphenyl, 2,4,6-tri-tert-butylphenyl, 2,4,6-trifluorophenyl, 2,4,6-trichlorophenyl, 2,4,6-tribromophenyl, 2,3,4,5,6-pentafluorophenyl, 2,3,4,5,6-pentachlorophenyl, 2,3,4,5,6-pentabromophenyl, and the like.

In some embodiments of Structures (IX), (X), and (XI), X is independently selected from fluoride, chloride, bromide, methyl, ethyl, phenyl, benzyl, phenyloxy, benzloxy, 2-phenyl-2-propoxy, 1-phenyl-2-propoxy, 1-phenyl-2-butoxy, 2-phenyl-2-butoxy and the like.

Non-limiting examples of the Group 15-containing catalyst component are represented by Structures (XIIa)-(XIIf) (where “N” is nitrogen):

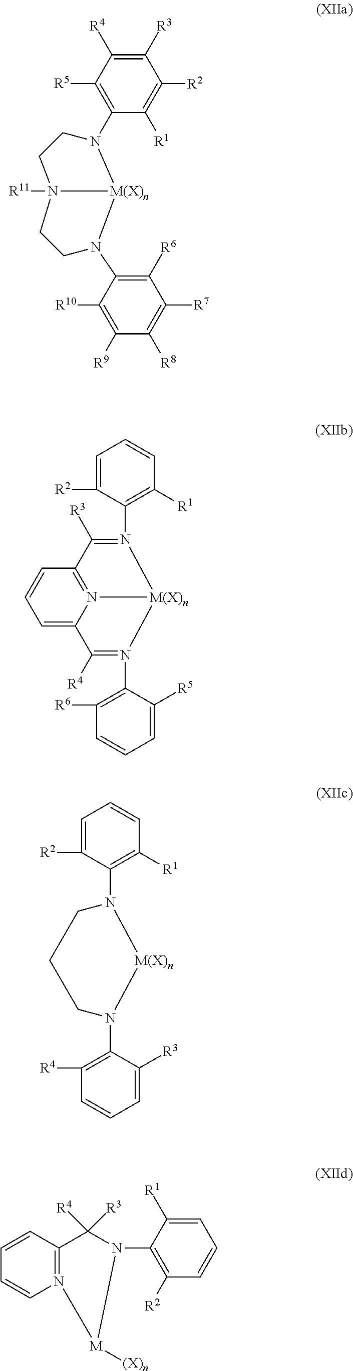

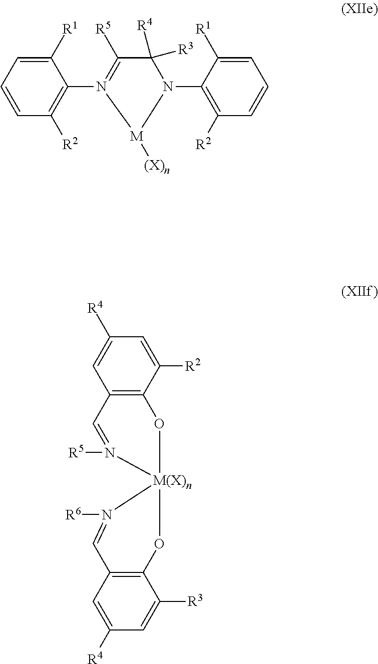

wherein in Structures (XIIa) through (XIIf), M is selected from Group 4 atoms or is selected from Zr and Hf; and wherein R¹ through R¹¹ in Structures (XIIa) through (XIIf) are selected from hydride, fluorine radical, chlorine radical, bromine radical, methyl, ethyl, n-propyl, isopropyl, n-butyl, isobutyl, tert-butyl and phenyl; and X is selected from fluorine ion, chlorine ion, bromine ion, methyl, phenyl, benzyl, phenyloxy and benzyloxy; and n is an integer ranging from 0 to 4, or from 2 to 3.

The catalyst may be a mixed catalyst which may comprise a bimetallic catalyst composition or a multi-catalyst composition. As used herein, the terms “bimetallic catalyst composition” and “bimetallic catalyst” include any composition, mixture, or system that includes two or more different catalyst components, each having a different metal group. The terms “multi-catalyst composition” and “multi-catalyst” include any composition, mixture, or system that includes two or more different catalyst components regardless of the metals. Therefore, the terms “bimetallic catalyst composition,” “bimetallic catalyst,” “multi-catalyst composition,” and “multi-catalyst” will be collectively referred to herein as a “mixed catalyst” unless specifically noted otherwise. In one example, the mixed catalyst includes at least one metallocene catalyst component and at least one non-metallocene component.

The catalyst can be or include a mixed catalyst that includes at least one metallocene component. The catalyst may be a mixed catalyst system that includes at least one metallocene component and at least one Group-15 containing component. The metallocene components and Group-15 containing components may be as described above. For example, the mixed catalyst may comprise [(2,4,6-Me₃C₆H₂)NCH₂CH₂]₂NHHfBz₂ or [(2,4,6-Me₃C₆H₂)NCH₂CH₂]₂NHZrBz₂ or [(2,3,4,5,6-Me₅C₆)NCH₂CH₂]₂NHZrBz₂, where Bz is a benzyl group, combined with bis(indenyl)zirconium dichloride, (pentamethylcyclopentadienyl)(n-propylcyclopentadienyl)zirconium dichloride, or (tetramethylcyclopentadienyl)(n-propylcyclopentadienyl)zirconium dichloride.

One or more embodiments provide the catalyst comprises a metallocene catalyst, a post-metallocene catalyst, a combination of first a post-metallocene catalyst and a second post-metallocene catalyst, a Ziegler-Natta catalyst, a combination of a post-metallocene catalyst and a Ziegler-Natta catalyst, a chrome-based catalyst, a combination of two different metallocene catalysts, or a combination of a metallocene catalyst and a post-metallocene catalyst.

An example of mixed catalyst system suitable for use herein are the PRODIGY™ Bimodal Catalysts available from Univation Technologies.

The polymerization process may be carried out such that the catalyst composition is heterogeneous and the catalyst composition comprises at least one support material. The support material may be any material known in the art for supporting catalyst compositions, such as an inorganic oxide, preferably silica, alumina, silica-alumina, magnesium chloride, graphite, magnesite, titania, zirconia, and montmorillonite, any of which can be chemically/physically modified such as by fluoriding processes, calcining, or other processes known in the art. In an embodiment, the support material may be a silica material having an average particle size as determined by Malvern analysis of from 0.1 to 100 μm, or 10 to 50 μm.

An activator may be used with the catalyst compound. As used herein, the term “activator” refers to any compound or combination of compounds, supported or unsupported, which can activate a catalyst compound or component, such as by creating a cationic species of the catalyst component. Illustrative activators include, but are not limited to, aluminoxane (e.g., methylaluminoxane “MAO”), modified aluminoxane (e.g., modified methylaluminoxane “MMAO” and/or tetraisobutyldialuminoxane “TIBAO”), and alkylaluminum compounds, ionizing activators (neutral or ionic) such as tri (n-butyl) ammonium tetrakis(pentafluorophenyl) boron may also be used, and combinations thereof. The molar ratio of metal in the activator to metal in the catalyst composition can range from 1000:0.1 to 0.5:1, 300:1 to 0.5:1, 150:1 to 1:1, 50:1 to 1:1, 10:1 to 0.5:1, or 3:1 to 0.3:1.

The catalyst compositions can include a support material or carrier. As used herein, the terms “support” and “carrier” are used interchangeably and refer to any support material, including a porous support material, for example, talc, inorganic oxides, and inorganic chlorides. The catalyst component(s) and/or activator(s) can be deposited on, contacted with, vaporized with, bonded to, or incorporated within, adsorbed or absorbed in, or on, one or more supports or carriers. Other support materials can include resinous support materials such as polystyrene, functionalized or crosslinked organic supports, such as polystyrene divinyl benzene polyolefins or polymeric compounds, zeolites, clays, or any other organic or inorganic support material and the like, or mixtures thereof. Relatively small, non-porous supports may be beneficial, e.g., silica particles having a diameter of about 15 to about 200 nm suitable for forming spray-dried catalyst particles having a diameter of about 20 to about 40 μm.

The catalyst may be selected from the group consisting of [(2,4,6-Me₃C₆H₂)NCH₂CH₂]₂NHHfBz₂, [(2,4,6-Me₃C₆H₂)NCH₂CH₂]₂NHZrBz₂ or [(2,3,4,5,6-Me₅C₆)NCH₂CH₂]₂NHZrBz₂, where Bz is a benzyl group and bis (n-propylcyclopentadienyl) hafnium dichloride. The catalyst composition may further include a catalyst selected from the group consisting of bis(indenyl)zirconium dichloride, (pentamethylcyclopentadienyl) (n-propylcyclopentadienyl)zirconium dichloride, or (tetramethylcyclopentadienyl) (n-propylcyclopentadienyl)zirconium dichloride.

The catalyst composition may comprise a bimodal catalyst composition. Thus, the catalyst composition may include a catalyst selected from the group consisting of [(2,4,6-Me₃C₆H₂)NCH₂CH₂]₂NHHfBz₂, [(2,4,6-Me₃C₆H₂)NCH₂CH₂]₂NHZrBz₂ or [(2,3,4,5,6-Me₅C₆)NCH₂CH₂]₂NHZrBz₂, where Bz is a benzyl group and bis (n-propylcyclopentadienyl) hafnium dichloride. It may further includes an additional metallocene catalyst selected from the group consisting of bis(indenyl)zirconium dichloride, dichloride, (pentamethylcyclopentadienyl) (n-propylcyclopentadienyl)zirconium or (tetramethylcyclopentadienyl) (n-propylcyclopentadienyl)zirconium dichloride.

The catalyst composition can be introduced to the catalyst delivery system or to the reactor at a flow rate from a low of about 0.001 kg/hr, about 0.005 kg/hr, about 0.02 kg/hr, 0.1 kg/hr, about 0.5 kg/hr, about 1 kg/hr, about 1.5 kg/hr, about 2 kg/hr, or about 3 kg/hr to a high of about 5 kg/hr, about 10 kg/hr, about 15 kg/hr, about 20 kg/hr, or about 25 kg/hr, with suitable ranges comprising the combination of any two values. For example, the catalyst can be introduced at a flow rate of about 0.4 kg/hr to about 23 kg/hr, about 1.4 kg/hr to about 14 kg/hr, or about 2.3 kg/hr to about 4.5 kg/hr. The catalyst can be or include fully formed catalyst particles suspended in one or more inert liquids, e.g., in the form of a catalyst slurry or suspension. For example, the concentration of the catalyst particles in a catalyst slurry can range from a low of about 1 wt %, about 5 wt %, about 12 wt %, or about 15 wt % to a high of about 20 wt %, about 23 wt %, about 25 wt %, or about 30 wt %, with suitable ranges comprising the combination of any two values. The catalyst can be slurried in any suitable liquid or combination of liquids. Suitable liquids for forming the catalyst slurry can include, but are not limited to, toluene, ethylbenzene, xylene, pentane, hexane, heptane, octane, other hydrocarbons, or any combination thereof. One or more mineral oils or other non-reactive liquid hydrocarbons can also be used to form the catalyst slurry. The catalyst system can also be in the form of a powder, e.g., a spray dried catalyst, a liquid, or a slurry.

The reactor can be operated in condensed mode using an ICA. The amount of ICAs that can be introduced to the reactor can provide an ICA concentration within the polymerization reactor ranging from a low of about 1 mol %, about 5 mol %, or about 10 mol % to a high of about 25 mol %, about 35 mol %, or about 45 mol %, with suitable ranges comprising the combination of any two values. For example, the concentration of the ICA(s), if present, can range from about 14 mol %, about 16 mol %, or about 18 mol % to a high of about 20 mol %, about 22 mol %, or about 24 mol %, with suitable ranges comprising the combination of any two values. Suitable ICAs are known in the art.

### Continuity Additives

As used herein, a continuity aid is a chemical composition which, when introduced into a fluidized bed reactor, may influence or drive a static charge (negatively, positively, or to zero) in the fluidized bed. The specific continuity aid used may depend upon the nature of the static charge, and the choice of continuity aid may vary dependent upon the polyolefin being produced and the catalyst compound(s) being used.

Continuity aids such as aluminum stearate may be employed. The continuity aid used may be selected for its ability to receive the static charge in the fluidized bed without adversely affecting productivity. Suitable continuity aid may include aluminum distearate, ethoxlated amines, and anti-static compositions such as those provided by Innospec Inc. under the trade name OCTASTAT. For example, OCTASTAT 2000 is a mixture of a polysulfone copolymer, a polymeric polyamine, and oil-soluble sulfonic acid.

Any of the aforementioned continuity aids, as well as those described in, for example, WO 01/44322, listed under the heading Carboxylate Metal Salt and including those chemicals and compositions listed as antistatic agents may be employed either alone or in combination as a control agent. For example, the carboxylate metal salt may be combined with an amine containing control agent (e.g., a carboxylate metal salt with any family member belonging to the KEMAMINE (available from Crompton Corporation) or ATMER (available from ICI Americas Inc.) family of products).

Other useful continuity additives include, ethyleneimine additives useful in embodiments disclosed herein may include polyethyleneimines having the following general formula:

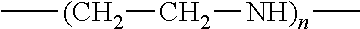

where n can be from about 10 to about 10,000. Commercial polyethyleneimine can be a compound having branches of the ethyleneimine polymer. Suitable polyethyleneimines are commercially available from BASF Corporation under the trade name Lupasol. Another useful continuity additive can include a mixture of aluminum distearate and an ethoxylated amine type compound, e.g., IRGASTAT AS-990, available from Huntsman (formerly Ciba Specialty Chemicals). The mixture of aluminum distearate and ethoxylated amine type compound can be slurried in mineral oil e.g., Hydrobrite 380. For example, the mixture of aluminum distearate and an ethoxylated amine type compound can be slurried in mineral oil to have total slurry concentration of ranging from about 5 wt % to about 50 wt % or about 10 wt % to about 40 wt %, or about 15 wt % to about 30 wt %.

The continuity additive(s) may be added to the reactor in an amount ≥0.05 ppm, e.g., ≥0.10 ppm, ≥1.0 ppm, ≥2.0 ppm, ≥4.0 ppm, ≥10.0 ppm, ≥20.0 ppm, ≥30.0 ppm, ≥40.0 ppm, ≥ 50.0 ppm, ≥60.0 ppm, ≥70.0 ppm, ≥80.0 ppm, ≥90.0 ppm, ≥100.0 ppm, ≥125.0 ppm, ≥150.0 ppm, or ≥175.0 ppm, based on the weight of all feeds to the reactor, excluding recycle. Additionally or alternatively the amount of continuity additive may be ≤200.0 ppm, e.g., ≤175.0 ppm, ≤150.0 ppm, ≤125.0 ppm, ≤100.0 ppm, ≤90.0 ppm, ≤80.0 ppm, ≤70.0 ppm, ≤60.0 ppm, ≤50.0 ppm, ≤40.0 ppm, ≤30.0 ppm, ≤20.0 ppm, ≤10.0 ppm, ≤4.0 ppm, ≤2.0 ppm, ≤1.0 ppm, or ≤0.10 ppm. Ranges of the concentration of the continuity aid that are expressly disclosed comprise ranges formed by pairs of any of the above-enumerated values, e.g., 2.0 to 100.0 ppm, 4.0 to 50.0 ppm, 10.0 to 40.0 ppm etc.

### Polyolefin Products

The polyolefin products, e.g., polyolefin particles, can be or include various types of polyolefin. Examples of polyolefins include, but are not limited to, polyolefins comprising one or more linear, branched or cyclic C₂ to C₄₀ olefins, preferably polymers comprising propylene copolymerized with one or more C₃ to C₄₀ olefins, preferably a C₃ to C₂₀ alpha olefin, or C₃ to C₁₀ alpha-olefins. Preferred polyolefins include, but are not limited to, polymers comprising ethylene, including but not limited to ethylene copolymerized with a C₃ to C₄₀ olefin, preferably a C₃ to C₂₀ alpha olefin, such as propylene and/or butene.

Preferred polyolefin products include homopolymers or copolymers of C₂ to C₄₀ olefins, preferably C₂ to C₂₀ olefins, such as copolymers of an alpha-olefin and another olefin or alpha-olefin (ethylene can be defined to be an alpha-olefin). In one or more embodiments, the polyolefin products are or include homopolyethylene, homopolypropylene, propylene copolymerized with ethylene and or butene, ethylene copolymerized with one or more of propylene, butene or hexene, and optional dienes. Examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymers of propylene and ethylene and/or butene and/or hexene, elastomers such as ethylene propylene rubber, ethylene propylene diene monomer rubber, neoprene, and blends of thermoplastic polymers and elastomers, such as for example thermoplastic elastomers and rubber toughened plastics. One or more embodiments provide that the polyolefin particles comprise a low-density polyethylene; or a linear low density polyethylene or a high-density polyethylene; or a very low linear density polyethylene. One or more embodiments provide that the polyolefin particles comprise polyethylene particles (e.g., a polyethylene homopolymer), polypropylene particles, or ethylene/(C4-C12)α-olefin copolymer particles (e.g., an ethylene/1-butene copolymer, an ethylene/1-hexene copolymer, or an ethylene/1-octene copolymer). One or more embodiments provide that one or more olefin monomers comprise ethylene, propylene, a (C4-C12)α-olefin, or a combination of any two or more thereof.

The polyolefin products may be characterized by their density. Density can be determined in accordance with ASTM D-792. Density is expressed as grams per cubic centimeter (g/cm³) unless otherwise noted. The polyolefin compositions can have a density of ≥ about 0.870 g/cm³, e.g., ≥ about 0.880 g/cm³, ≥ about 0.890 g/cm³, ≥ about 0.900 g/cm³, ≥ about 0.910 g/cm³, ≥ about 0.920 g/cm³, ≥ about 0.930 g/cm³, ≥ about 0.940 g/cm³, ≥ about 0.950 g/cm³, or ≥ about 0.960 g/cm³. Additionally or alternatively, the density of the polyolefin compositions may be ≤ about 0.970 g/cm³, e.g., ≤ about 0.970 g/cm³, ≤ about 0.970 g/cm³, ≤ about 0.970 g/cm³, ≤ about 0.960 g/cm³, ≤ about 0.950 g/cm³, ≤ about 0.940 g/cm³, ≤ about 0.930 g/cm³, ≤ about 0.920 g/cm³, ≤ about 0.910 g/cm³, ≤ about 0.900 g/cm³, ≤ about 0.890 g/cm³, ≤ or about 0.880 g/cm³.

The polyolefin products may be characterized by Flow Index, also referred to as I₂₁ or I_{21.6}. The Flow Index may be ≥ about 1.0, e.g., ≥ about 2.0, ≥ about 2.5, ≥ about 4.0, ≥ about 5.0, ≥ about 7.0, ≥ about 10.0, ≥ about 25.0, ≥ about 50.0, ≥ about 100.0, ≥ about 125.0, ≥ about 250.0, ≥ about 500.0, or ≥ about 750.0. Additionally or alternatively the Flow Index may be ≤ about 1000.0 g/10 min., e.g., ≤ about 750.0 g/10 min., ≤ about 500.0 g/10 min., ≤ about 250.0 g/10 min., ≤ about 125.0 g/10 min., ≤ about 100.0 g/10 min., ≤ about 50.0 g/10 min., ≤ about 25.0 g/10 min., ≤ about 10.0 g/10 min., ≤ about 7.0 g/10 min., ≤ about 5.0 g/10 min., ≤ about 4.0 g/10 min., ≤ about 2.5 g/10 min., or ≤ about 2.0 g/10 min. Ranges of the Flow Index of the polyolefin compositions made by processes herein comprise ranges formed by any of the combination of the values expressly disclosed, e.g., about 1.0 to about 1000.0 g/10 min, about 2.0 to about 750.0 g/10 min, about 2.5 to about 500.0 g/10 min, about 4.0 to about 250.0 g/10 min, about 5.0 to about 125.0 g/10 min, about 7.0 to about 100.0 g/10 min, about 10.0 to about 50.0 g/10 min, etc.

A number of aspects of the present disclosure are provided as follows.

Aspect 1 provides a method for decreasing triboelectric charging of, and/or reactor fouling by, polyolefin particles in a fluidized bed-type gas phase polymerization reactor (FBT-GPP reactor) comprising a distributor plate and a wall defining a reaction zone, wherein the polyolefin particles are located in the reaction zone and the reaction zone is located above and in fluid communication with the distributor plate, the method comprising: feeding an argon gas/nitrogen gas mixture upward through the distributor plate into the reaction zone to fluidize the polyolefin particles in the reaction zone, wherein the argon gas/nitrogen gas mixture consists of from 5 volume percent (vol %) to no more than 65 vol % argon gas, from 95 vol % to no less than 10 vol % nitrogen gas, and from 0 vol % to no more than 5 vol % helium gas, wherein the sum of all these vol % equals 100 vol % of the argon gas/nitrogen gas mixture.

Aspect 2 provides the method of Aspect 1, wherein decreasing triboelectric charging means that the electric charge of the polyolefin particles is lower than the electric charge of polyolefin particles in a comparative method using an inert gas that is 100 vol % nitrogen gas in place of the argon gas/nitrogen gas mixture; and wherein the triboelectric charge of the polyolefin particles is measured on a sample of the polyolefin particles that have been removed from the FBT-GPP reactor wherein the measurement is done according to Charge Measurement Test Method described herein; or wherein the FBT-GPP reactor comprises a static probe and the triboelectric charge of the polyolefin particles is measured by the static probe; and/or wherein decreasing reactor fouling means that an amount of adhered polyolefin material, if any, in the FBT-GPP reactor is lower relative to an amount of adhered polyolefin material in the FBT-GPP reactor of a comparative method using an inert gas that is 100 vol % nitrogen gas in place of the argon gas/nitrogen gas mixture.

Aspect 3 provides the method of Aspect 1 or Aspect 2, wherein the argon gas/nitrogen gas mixture has any one of limitations (i) to (v): (i) the amount of argon gas is: (a) from 9 vol % to no more than 65 vol % argon gas, (b) from 10 vol % to no more than 60 vol % argon gas, (c) from 10 vol % to no more than 55 vol % argon gas, (d) from 10 vol % to no more than 50 vol % argon gas, (e) from 10 vol % to no more than 45 vol % argon gas, or (f) from 10 vol % to no more than 35 vol % argon gas; (ii) the amount of nitrogen gas is: (a) from 90 vol % to no less than 35 vol % nitrogen gas, (b) from 90 vol % to no less than 40 vol % nitrogen gas, (c) from 90 vol % to no less than 45 vol % nitrogen gas, (d) from 90 vol % to no less than 50 vol % nitrogen gas, (e) from 90 vol % to no less than 55 vol % nitrogen gas, or (f) from 90 vol % to no less than 65 vol % nitrogen gas; (iii) the amounts of argon gas and nitrogen gas are selected from the group consisting of: limitations (i)(a) and (ii)(a), limitations (i)(b) and (ii)(b), limitations (i)(c) and (ii)(c), limitations (i)(d) and (ii)(d), limitations (i)(e) and (ii)(e), or limitations (i)(f) and (ii)(f); (iv) the argon gas/nitrogen gas mixture lacks helium (i.e., 0 vol % helium); or (v) limitation (iv) and any one of limitations (i) to (iii).

Aspect 4 provides the method of Aspect 1, Aspect 2, or Aspect 3, having any one of limitations (i) to (iii): (i) wherein the decreasing triboelectric charging means that the triboelectric charge of the polyolefin particles after 10 hours of fluidization by the argon gas/nitrogen gas mixture is lower by at least 10%, alternatively by at least 20%, alternatively at least 30%, relative to triboelectric charge of a comparative polyolefin particles that have been fluidized for 10 hours in a comparative method by using an inert gas that is 100 vol % nitrogen gas in place of the argon gas/nitrogen gas mixture; (ii) wherein the decreasing reactor fouling means that an amount of adhered polyolefin material, if any, in the FBT-GPP reactor after 10 hours is lower by at least 10%, alternatively by at least 20%, alternatively at least 30%, relative to an amount of adhered polyolefin material in the FBT-GPP reactor after 10 hours of a comparative method using an inert gas that is 100 vol % nitrogen gas in place of the argon gas/nitrogen gas mixture and wherein the amount of adhered polyolefin material equals any one of amounts (a) to (d): (a) the weight of polyolefin particles adhered to the distributor plate, (b) the weight of polyolefin particles adhered to the reactor wall, or (c) the total of the weights (a) to (b); or (iii) both limitations (i) and (ii).

Aspect 5 provides the method of Aspect 1, Aspect 2, Aspect 3, or Aspect 4, wherein the FBT-GPP reactor comprises, in sequential fluid communication, a bottom zone, the distributor plate, the wall defining the reaction zone, a wall defining a velocity reduction zone, a recycle line, and a compressor, lines for inletting feeds, and an outlet for removing polyolefin particles, and optionally a static probe; wherein the recycle line fluidly connects the velocity reduction zone to the compressor and the compressor to the bottom zone.

Aspect 6 provides the method of Aspect 5 comprising contacting in the reaction zone a feed of an olefin polymerization catalyst and a feed of one or more olefin monomers to polymerize the one or more olefin monomers and make the polyolefin particles, wherein the feeding of the argon gas/nitrogen gas mixture and the contacting steps are performed at the same time; wherein the feeding or feedings of the one or more olefin monomers comprises injecting the one or more olefin monomers into the bottom zone, the reaction zone, the recycle line, or a combination of any two or more thereof; wherein the feeding of the polymerization catalyst comprises injecting the olefin polymerization catalyst into the reaction zone, the velocity reduction zone, or both; and wherein the feeding of the argon gas/nitrogen gas mixture comprises injecting the argon gas/nitrogen gas mixture into the bottom zone, the recycle line, or both; wherein a recycle gas mixture comprising one or more process gases, has been removed from the velocity reduction zone, compressed by the compressor, and fed into the bottom zone, all via the recycle line.

Aspect 7 provides the method of Aspect 6 wherein the olefin polymerization catalyst is fed as a dry solid or a slurry, the slurry comprising solid olefin polymerization catalyst dispersed in a saturated hydrocarbon (e.g., mineral oil or isopentane).

Aspect 8 provides the method of Aspect 6 or Aspect 7, wherein the one or more olefin monomers comprises ethylene, propylene, a (C4-C12)α-olefin, or a combination of any two or more thereof; wherein the olefin polymerization catalyst comprises a metallocene catalyst, a post-metallocene catalyst, a combination of first a post-metallocene catalyst and a second post-metallocene catalyst, a Ziegler-Natta catalyst, a combination of a post-metallocene catalyst and a Ziegler-Natta catalyst, a chrome-based catalyst, a combination of two different metallocene catalysts, or a combination of a metallocene catalyst and a post-metallocene catalyst; and wherein the polyolefin particles comprise polyethylene particles (e.g., a polyethylene homopolymer), polypropylene particles, or ethylene/(C4-C12)α-olefin copolymer particles (e.g., an ethylene/1-butene copolymer, an ethylene/1-hexene copolymer, or an ethylene/1-octene copolymer).

Aspect 9 provides the method of Aspect 1, Aspect 2, Aspect 3, Aspect 4, Aspect 5, Aspect 6, Aspect 7, or Aspect 8, wherein the polyolefin particles comprise a low-density polyethylene; or wherein the polyolefin particles comprise a linear low density polyethylene or a high-density polyethylene; or wherein the polyolefin particles comprise a very low linear density polyethylene.

Aspect 10 provides the method of Aspect 1, Aspect 2, Aspect 3, Aspect 4, Aspect 5, Aspect 6, Aspect 7, Aspect 8, or Aspect 9, wherein the method comprises operating an olefin polymerization process in the FBT-GPP reactor at an operating temperature from 70° C. to 120° C. and an operating total pressure of 1,500 kilopascals (kPa) to 3,000 kPa.

Aspect 11 provides the method of Aspect 1, Aspect 2, Aspect 3, Aspect 4, Aspect 5, Aspect 6, Aspect 7, Aspect 8, or Aspect 9, wherein the method comprises starting-up the FBT-GPP reactor wherein during the starting-up the temperature of the polyolefin particles in the reaction zone is from 20° C. to less than 80° C. and the total pressure in the reaction zone is from 100 kilopascals (kPa) to less than 1,500 kPa.

Aspect 12 provides the method of Aspect 1, Aspect 2, Aspect 3, Aspect 4, Aspect 5, Aspect 6, Aspect 7, Aspect 8, Aspect 9, Aspect 10, or Aspect 11, wherein the polyolefin particles are also fluidized by one or more process gases selected from the group consisting of: hydrogen gas, one or more olefin monomer gases, and one or more alkane gases, wherein the one or more process gases independently may be freshly fed into the reaction zone of the FBT-GPP reactor or fed in a recycle gas mixture upward through the distributor plate into the reaction zone the FBT-GPP reactor or a combination thereof.

Aspect 13 provides the method of Aspect 1, Aspect 2, Aspect 3, Aspect 4, Aspect 5, Aspect 6, Aspect 7, Aspect 8, Aspect 9, Aspect 10, Aspect 11, or Aspect 12 comprising feeding the argon gas/nitrogen gas mixture upward through the distributor plate into the reaction zone comprises for a fixed time interval.

Aspect 14 provides the method of Aspect 1, Aspect 2, Aspect 3, Aspect 4, Aspect 5, Aspect 6, Aspect 7, Aspect 8, Aspect 9, Aspect 10, Aspect 11, Aspect 12, or Aspect 13, wherein feeding the argon gas/nitrogen gas mixture upward through the distributor plate into the reaction zone comprises is responsive to a deviation from a steady-state polymerization process condition.

Aspect 15 provides a method for lowering static charge in a fluidized bed-type gas phase polymerization reactor (FBT-GPP reactor), the method comprising: feeding a startup gas to the FBT-GPP reactor to provide a startup gas environment, wherein the startup gas consists of from 80 volume percent (vol %) to 100 vol % argon gas and 0 vol % to 20% nitrogen gas, wherein the sum of all these vol % equals 100 vol % of the startup gas.

Aspect 16 provides the method of Aspect 15, wherein no polymerization catalyst is being fed to the FBT-GPP reactor while feeding the startup gas.

Aspect 17 provides the method Aspect 15 or Aspect 16, wherein the startup gas environment is maintained from 5 minutes to 12 hours.

### EXAMPLES

Example 1 was performed as follows.

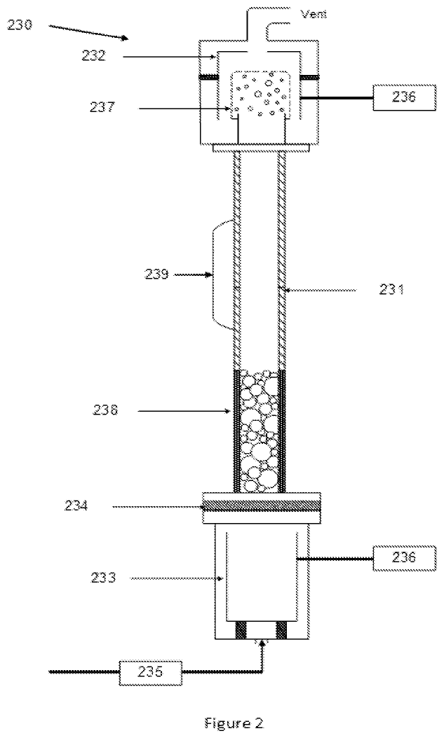

FIG. 2 depicts a schematic of an example system 230 in accordance with a number of embodiments described herein. A stainless-steel column 231 (inner diameter 10 cm; column height 1.2 m) was fitted with one Faraday cage 232 at the top of the column and one Faraday cage 233 at the bottom of the column; a valve 234 (knife gate valve having a perforated stainless steel gate) was located just above the lower Faraday cage; a mass flow controller 235 (MKS model 1559) was utilized to measure and regulate the flow of gas into the column. The mass flow controller was calibrated for air/nitrogen and a gas correction factor was utilized for argon. A first hygrometer was used to measure relative humidity and temperature of the gas; as second hygrometer was used to measure environmental relative humidity and temperature. Electrostatic charge of the particles was measured with the two Faraday cages, each of which was connected to a digital electrometer 236 (Keithley 6514). LabVIEW software was used for controlling and recording parameters.

The valve was closed and polyolefin particles (1 kg; LLDPE; particle size distribution 20-2000 μm; particle Sauter-mean diameter 947 μm; particle density 917 kg/m³; obtained from UNIVATION TECHNOLOGIES, LLC) was poured into the column. After loading the polyolefin particles, a filter bag 237 was attached to the column, inside the top Faraday cage. The top Faraday cage was open to atmosphere to allow fluidizing gas to vent to a piping attached to a fume hood. Fluidizing gas was fed into the bottom of the column, below both the lower Faraday cage and the valve. The fluidizing gas for gas mixture trials were fed through two different flowmeters at predetermined flowrates. Successive fluidization was also carried out, wherein the particles where fluidized by pure Nitrogen for 50 minutes, Thereafter, Nitrogen flow was reduced while simultaneously increasing the flow of Argon, until it reached the desired flowrate. The particles where then fluidized by pure Argon for an additional 10 minutes. In all the trials, the fluidizing gas was ramped to a gas velocity of where U−U_{mf} was kept at 0.1 m/s to fluidize the polyolefin particles for approximately 60 minutes. During the fluidization, the charge of entrained fines was cumulatively measured with the top Faraday cage. After the fluidization, the flow of the fluidization gas was stopped and the filter bag was removed to measure the mass of fines collected therein. The mass (m) and electrostatic charge (Q) of fines collected (entrained fine particles) were recorded. Then, the valve was opened, and the bulk of the fluidizing particles were collected in the bottom Faraday cage; those particles were used to determine the net charge-to-mass ratio (Q/m) (bulk particles). Then, the bottom Faraday cage was cleaned and reattached. Then, the inner column surface was inspected for particles adhering to the column (fouling particles) due to triboelectric charging. Two regions along the column wall were identified including, region 1 238 that was between the distributor plate and the static bed height, and region 2 239 that was between the static bed height and the exit of the column (i.e., consisted of the expanded bed height and the freeboard sections). Particles adhering to the column in each of the regions 1 and 2 were separately dislodged with jets of compressed dry air, collected in the bottom Faraday cage to measure mass and charge for net Q/m determination. The column was then cleaned and vented for subsequent runs. Examples 2-5 and Comparative Example A were performed as Example 1, with the differing fluidizing gases shown in Tables 1-2.

TABLE 1

| | Example 1 | Example 2 | Example 3 | |
|---|---|---|---|---|
| | Argon | Argon | Argon | Comparative |
| | (10 vol %); | (25 vol %); | (50 vol %); | Example A |
| | Nitrogen | Nitrogen | Nitrogen | Nitrogen |
| Fluidizing gas | (90 vol %) | (75 vol %) | (50 vol %) | (100 vol %) |
| Region-1 | 1.13 | 0.97 | 0.90 | 2.01 |
| charge (nC) | | | | |
| Region 1 | 10.46 | 5.41 | 5.26 | 20.08 |
| fouling mass | | | | |
| (g) | | | | |
| Region 2 | 1.17 | 1.53 | 1.21 | 1.62 |
| fouling mass | | | | |
| (g) | | | | |
| Total Fouling | 11.65 | 6.93 | 6.47 | 21.59 |
| mass (g) | | | | |
| Mass of fines | 2.70 | 2.33 | 2.47 | 2.30 |
| (g) | | | | |

The data of Table 1 show that each of Examples 1-3 had an improved, e.g., decreased, particle charge in region 1, as compared to Comparative Example A. The data of Table 1 also show that each of Examples 1-3 had an improved, e.g., decreased, fouling particle total mass, as compared to Comparative Example A. Decreased fouling, i.e., fouling particle total mass, is desirable for a number of applications. The data of Table 1 also show no significant difference in fouling particle mass in region 2, as well as mass of fine particles entrained, as expected, because of low particle contacts and less charge dissipation.

TABLE 2

| | | Example 5 |
|---|---|---|
| | | Nitrogen |
| | | (100 vol %, |
| | | 50 minutes); |
| | | followed by |
| | Example 4 | Argon |
| | Argon | (100 vol %, |
| Fluidizing gas | (100 vol %) | 10 minutes) |
| Region-1 | 0.03 | 0.13 |
| charge (nC) | | |
| Region 1 | 0.92 | 1.55 |
| fouling mass | | |
| (g) | | |
| Region 2 | 1.07 | 1.30 |
| fouling mass | | |
| (g) | | |
| Total Fouling | 1.98 | 2.86 |
| mass (g) | | |
| Mass of fines | 2.19 | 2.67 |
| (g) | | |

The data of Table 2 show that each of Examples 4-5 had an improved, e.g., decreased, particle charge in region 1, as compared to Comparative Example A (See Table 1). The data of Table 2 also show that each of Examples 4-5 had an improved, e.g., decreased, fouling particle total mass, as compared to Comparative Example A (See Table 1). Examples 4-5 provide a number of conditions that may be observed during a startup procedure, for instance, where argon may be considered a startup gas.

1. A method for decreasing triboelectric charging of, and/or reactor fouling by, polyolefin particles in a fluidized bed-type gas phase polymerization reactor (FBT-GPP reactor) comprising a distributor plate and a wall defining a reaction zone, wherein the polyolefin particles are located in the reaction zone and the reaction zone is located above and in fluid communication with the distributor plate, the method comprising:
feeding an argon gas/nitrogen gas mixture upward through the distributor plate into the reaction zone to fluidize the polyolefin particles in the reaction zone, wherein the argon gas/nitrogen gas mixture consists of from 5 volume percent (vol %) to no more than 65 vol % argon gas, from 95 vol % to no less than 10 vol % nitrogen gas, and from 0 vol % to no more than 5 vol % helium gas, wherein the sum of all these vol % equals 100 vol % of the argon gas/nitrogen gas mixture.

2. The method of claim 1:
wherein decreasing triboelectric charging means that the electrostatic charge of the polyolefin particles is lower than the electrostatic charge of polyolefin particles in a comparative method using an inert gas that is 100 vol % nitrogen gas in place of the argon gas/nitrogen gas mixture; and
wherein the triboelectric charge of the polyolefin particles is measured on a sample of the polyolefin particles that have been removed from the FBT-GPP reactor wherein the measurement is done according to Charge Measurement Test Method described herein; or wherein the FBT-GPP reactor comprises a static probe and the triboelectric charge of the polyolefin particles is measured by the static probe; and/or
wherein decreasing reactor fouling means that an amount of adhered polyolefin material, if any, in the FBT-GPP reactor is lower relative to an amount of adhered polyolefin material in the FBT-GPP reactor of a comparative method using an inert gas that is 100 vol % nitrogen gas in place of the argon gas/nitrogen gas mixture.

3. The method of claim 1 wherein the argon gas/nitrogen gas mixture has any one of limitations (i) to (v):
(i) the amount of argon gas is: (a) from 9 vol % to no more than 65 vol % argon gas, (b) from 10 vol % to no more than 60 vol % argon gas, (c) from 10 vol % to no more than 55 vol % argon gas, (d) from 10 vol % to no more than 50 vol % argon gas, (e) from 10 vol % to no more than 45 vol % argon gas, or (f) from 10 vol % to no more than 35 vol % argon gas;
(ii) the amount of nitrogen gas is: (a) from 90 vol % to no less than 35 vol % nitrogen gas, (b) from 90 vol % to no less than 40 vol % nitrogen gas, (c) from 90 vol % to no less than 45 vol % nitrogen gas, (d) from 90 vol % to no less than 50 vol % nitrogen gas, (e) from 90 vol % to no less than 55 vol % nitrogen gas, or (f) from 90 vol % to no less than 65 vol % nitrogen gas;
(iii) the amounts of argon gas and nitrogen gas are selected from the group consisting of: limitations (i)(a) and (ii)(a), limitations (i)(b) and (ii)(b), limitations (i)(c) and (ii)(c), limitations (i)(d) and (ii)(d), limitations (i)(e) and (ii)(e), or limitations (i)(f) and (ii)(f);
(iv) the argon gas/nitrogen gas mixture lacks helium (i.e., 0 vol % helium); or
(v) limitation (iv) and any one of limitations (i) to (iii).

4. The method of claim 1 having any one of limitations (i) to (iii):
(i) wherein the decreasing triboelectric charging means that the triboelectric charge of the polyolefin particles after 10 hours of fluidization by the argon gas/nitrogen gas mixture is lower by at least 10%, alternatively by at least 20%, alternatively at least 30%, relative to triboelectric charge of a comparative polyolefin particles that have been fluidized for 10 hours in a comparative method by using an inert gas that is 100 vol % nitrogen gas in place of the argon gas/nitrogen gas mixture;
(ii) wherein the decreasing reactor fouling means that an amount of adhered polyolefin material, if any, in the FBT-GPP reactor after 10 hours is lower by at least 10%, alternatively by at least 20%, alternatively at least 30%, relative to an amount of adhered polyolefin material in the FBT-GPP reactor after 10 hours of a comparative method using an inert gas that is 100 vol % nitrogen gas in place of the argon gas/nitrogen gas mixture and wherein the amount of adhered polyolefin material equals any one of amounts (a) to (d): (a) the weight of polyolefin particles adhered to the distributor plate, (b) the weight of polyolefin particles adhered to the reactor wall, or (c) the total of the weights (a) to (b); or
(iii) both limitations (i) and (ii).

5. The method of claim 1, wherein the FBT-GPP reactor comprises, in sequential fluid communication, a bottom zone, the distributor plate, the wall defining the reaction zone, a wall defining a velocity reduction zone, a recycle line, and a compressor, lines for inletting feeds, and an outlet for removing polyolefin particles, and optionally a static probe; wherein the recycle line fluidly connects the velocity reduction zone to the compressor and the compressor to the bottom zone.

6. The method of claim 5, comprising contacting in the reaction zone a feed of an olefin polymerization catalyst and a feed of one or more olefin monomers to polymerize the one or more olefin monomers and make the polyolefin particles, wherein the feeding of the argon gas/nitrogen gas mixture and the contacting steps are performed at the same time; wherein the feeding or feedings of the one or more olefin monomers comprises injecting the one or more olefin monomers into the bottom zone, the reaction zone, the recycle line, or a combination of any two or more thereof; wherein the feeding of the polymerization catalyst comprises injecting the olefin polymerization catalyst into the reaction zone, the velocity reduction zone, or both; and wherein the feeding of the argon gas/nitrogen gas mixture comprises injecting the argon gas/nitrogen gas mixture into the bottom zone, the recycle line, or both; wherein a recycle gas mixture comprising one or more process gases, has been removed from the velocity reduction zone, compressed by the compressor, and fed into the bottom zone, all via the recycle line.

7. The method of claim 6, wherein the olefin polymerization catalyst is fed as a dry solid or a slurry, the slurry comprising solid olefin polymerization catalyst dispersed in a saturated hydrocarbon (e.g., mineral oil or isopentane).

8. The method of claim 6, wherein the one or more olefin monomers comprises ethylene, propylene, a (C4-C12)α-olefin, or a combination of any two or more thereof; wherein the olefin polymerization catalyst comprises a metallocene catalyst, a post-metallocene catalyst, a combination of first a post-metallocene catalyst and a second post-metallocene catalyst, a Ziegler-Natta catalyst, a combination of a post-metallocene catalyst and a Ziegler-Natta catalyst, a chrome-based catalyst, a combination of two different metallocene catalysts, or a combination of a metallocene catalyst and a post-metallocene catalyst; and wherein the polyolefin particles comprise polyethylene particles (e.g., a polyethylene homopolymer), polypropylene particles, or ethylene/(C4-C12)α-olefin copolymer particles (e.g., an ethylene/1-butene copolymer, an ethylene/1-hexene copolymer, or an ethylene/1-octene copolymer).

9. The method of claim 1, wherein the polyolefin particles comprise a low-density polyethylene; or wherein the polyolefin particles comprise a linear low density polyethylene or a high-density polyethylene; or wherein the polyolefin particles comprise a very low linear density polyethylene.

10. The method of any claim 1, wherein the method comprises operating an olefin polymerization process in the FBT-GPP reactor at an operating temperature from 70° C. to 120° C. and an operating total pressure of 1,500 kilopascals (kPa) to 3,000 kPa.

11. The method of claim 1, wherein the method comprises starting-up the FBT-GPP reactor wherein during the starting-up the temperature of the polyolefin particles in the reaction zone is from 20° C. to less than 80° C. and the total pressure in the reaction zone is from 100 kilopascals (kPa) to less than 1,500 kPa.

12. The method of claim 1, wherein the polyolefin particles are also fluidized by one or more process gases selected from the group consisting of: hydrogen gas, one or more olefin monomer gases, and one or more alkane gases, wherein the one or more process gases independently may be freshly fed into the reaction zone of the FBT-GPP reactor or fed in a recycle gas mixture upward through the distributor plate into the reaction zone the FBT-GPP reactor or a combination thereof.

13. The method of claim 1, comprising feeding the argon gas/nitrogen gas mixture upward through the distributor plate into the reaction zone comprises for a fixed time interval.

14. The method of any claim 1, wherein feeding the argon gas/nitrogen gas mixture upward through the distributor plate into the reaction zone comprises is responsive to a deviation from a steady-state polymerization process condition.

15. A method for lowering static charge in a fluidized bed-type gas phase polymerization reactor (FBT-GPP reactor), the method comprising:
feeding a startup gas to the FBT-GPP reactor to provide a startup gas environment, wherein the startup gas consists of from 80 volume percent (vol %) to 100 vol % argon gas and 0 vol % to 20% nitrogen gas, wherein the sum of all these vol % equals 100 vol % of the startup gas.

16. The method of claim 15, wherein no polymerization catalyst is being fed to the FBT-GPP reactor while feeding the startup gas.

17. The method of any claim 15, wherein the startup gas environment is maintained from 5 minutes to 12 hours.
